(19) United States
(12) Patent Application Publication
(10) Pub. No.: US 2023/0265714 A1
(43) Pub. Date: Aug. 24, 2023

(54) SLAT FOR VENETIAN BLIND

(71) Applicant: SHEEN WORLD TECHNOLOGY CORPORATION, TAICHUNG CITY (TW)

(72) Inventor: PO-YU CHEN, TAICHUNG CITY (TW)

(21) Appl. No.: 17/675,435

(22) Filed: Feb. 18, 2022

(51) Int. Cl. E06B 9/307

(52) U.S. Cl. CPC E06B 9/307

(57) ABSTRACT

A slat includes two through holes each provided at its periphery wall with a first wall surface and a second wall surface. First and second teeth protrude from the front and rear ends of the first wall surface towards the second wall surface. The distances between the first and second teeth and the second wall surface are smaller than the diameter of a lifting cord. A third tooth staggered with the first tooth and a fourth tooth staggered with the second tooth protrude from the front and rear ends of the second wall surface towards the first wall surface. The distances between the third and fourth teeth and the first wall surface are smaller than the diameter of the lifting cord. As such, the slat prevents a rope loop from being enlarged for enhancing the safety of use.

### BACKGROUND OF THE INVENTION

### 1. Field of the Invention

The present invention relates to a venetian blind and more particularly, to a slat for a venetian blind.

### 2. Description of the Related Art

A conventional venetian blind has a gap between two adjacent slats, such that the lifting cord exposed through the gap may be pulled out by children to form a rope loop. Because the through hole of the slat penetrated by the lifting cord has two arc-shaped closed ends, the movement of the lifting cord can't be limited, such that the lifting cord may be drawn out continuously. This will cause the rope loop to be enlarged. As a result, the neck of children may be easily wrapped by the enlarged rope loop, and therefore there are doubts about the safety of use.

In order to solve the aforesaid problem, the venetian blind disclosed by CN 203321285 U provides a clamping groove connected with each of two ends of the through hole. The width of the clamping groove is smaller than the diameter of the lift cord. The movement of the lift cord is limited by the clamping groove to prevent the rope loop from being enlarging continuously, such that the safety of use is improved. However, the structural strength of the slat is damaged by the clamping grooves, and further, the conventional slat is mostly made by plastic material and formed by compression molding so as to have a certain thickness. Under this circumstance, it is difficult to machine the clamping groove with the width smaller than the diameter of the lifting rope. Therefore, there is still room for improvement within the aforesaid prior art.

### SUMMARY OF THE INVENTION

It is a primary objective of the present invention to provide a slat for a venetian blind, which is easy to be manufactured and can prevent a rope loop from being enlarged, thereby enhancing the safety of use.

To attain the above objective, the slat of the present invention comprises two through holes at its left and right ends. Each of the through holes is adapted for penetration of a lifting cord. The periphery wall of each of the through holes has a first wall surface, a second wall surface, and two end surfaces. The first and second wall surfaces are opposite to each other. The end surfaces are opposite to each other and connected with the front and rear ends of the first wall surface and the front and rear ends of the second wall surface. A first tooth and a second tooth protrude from the front and rear ends of the first wall surface towards the second wall surface, respectively. The first tooth has a first tooth peak defining a distance with the second wall surface smaller than the diameter of the lifting cord. The second tooth has a second tooth peak defining a distance with the second wall surface smaller than the diameter of the lifting cord. A third tooth and a fourth tooth protrude from the front and rear ends of the second wall surface towards the first wall surface, respectively. The third tooth and the first tooth are staggered with respect to each other, and the fourth tooth and the second tooth are staggered with respect to each other. The third tooth has a third tooth peak defining a distance with the first wall surface smaller than the diameter of the lifting cord. The fourth tooth has a fourth tooth peak defining a distance with the first wall surface smaller than the diameter of the lifting cord.

It can be understood from the above illustration that when the lifting cord is pulled to one end of the through hole, the lifting cord is engaged between the first and third teeth or the second and fourth teeth so as to be unable to move. This can prevent a rope loop formed by pulling the lifting cord from being enlarged continuously, thereby enhancing the safety of use. In addition, compared to prior art, the slat of the present invention is easier to be manufactured for reducing manufacturing costs.

Preferably, the first tooth further has a first front tooth surface, and the third tooth further has a third rear tooth surface. The first front tooth surface of the first tooth and the third rear tooth surface of the third tooth are opposite and parallel to each other. The distance between the first front tooth surface of the first tooth and the third rear tooth surface of the third tooth is smaller than the diameter of the lifting cord. In addition, the second tooth further has a second front tooth surface and the fourth tooth further has a fourth rear tooth surface. The distance between the second front tooth surface of the second tooth and the fourth rear tooth surface of the four tooth is smaller than the diameter of the lifting cord. As such, the lifting cord is easier to enter between the first tooth and the third tooth or the second tooth and the fourth tooth.

Preferably, the first tooth further has a first rear tooth surface. The length of the first rear tooth surface is greater than the length of the first front tooth surface. As such, the lifting cord can be guided to enter between the first tooth and the third tooth by meaning of the first rear tooth surface with longer length.

Preferably, the fourth tooth further has a fourth front tooth surface. The length of the fourth front tooth surface is greater than the length of the fourth rear tooth surface. As such, the lifting cord can be guided to enter between the second tooth and the fourth tooth by meaning of the fourth front tooth surface with longer length.

Preferably, two first teeth protrude from the front end of the first wall surface towards the second wall surface. The third tooth is located between the two first teeth. Two fourth teeth protrude from the rear end of the second wall surface towards the first wall surface. The second tooth is located between the two fourth teeth.

Preferably, the first teeth each have a first front tooth surface and a first rear tooth surface, and the third tooth further has a third front tooth surface and a third rear tooth surface. The first front tooth surface of the first tooth located behind the third tooth and the third rear tooth surface of the third tooth are opposite and parallel to each other, and the distance between themselves is smaller than the diameter of the lifting cord. The first rear tooth surface of the first tooth located ahead of the third tooth and the third front tooth surface of the third tooth are opposite and parallel to each other, and the distance between themselves is smaller than the diameter of the lifting cord. In addition, the second tooth further has a second front tooth surface and a second rear tooth, and the fourth teeth each have a fourth front tooth surface and a fourth rear tooth surface. The fourth rear tooth surface of the fourth tooth located ahead of the second tooth and the second front tooth surface of the second tooth are opposite and parallel to each other, and the distance between themselves is smaller than the diameter of the lifting cord. The fourth front tooth surface of the fourth tooth located behind the second tooth and the second rear tooth surface of the second tooth are opposite and parallel to each other, and the distance between themselves is smaller than the diameter of the lifting cord. As such, the lifting cord is easier to enter between the first teeth and the third tooth or the second tooth and the fourth teeth.

Preferably, the length of the first rear tooth surface of the first tooth located behind the third tooth is greater than the length of the first front tooth surface of the first tooth located behind the third tooth. As such, the lifting cord can be guided to enter between the first tooth and the third teeth by meaning of the first rear tooth surface with longer length.

Preferably, the length of the fourth front tooth surface of the fourth tooth located ahead of the second tooth is greater than the length of the fourth rear tooth surface of the fourth tooth located ahead of the second tooth. As such, the lifting cord can be guided to enter between the second tooth and the fourth teeth by meaning of the fourth front tooth surface with longer length.

Preferably, the through holes each have an elongated shape. The extending directions of the through holes are perpendicular to the longitude direction of the slat.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a venetian blind using a slat according to the first embodiment of the present invention.

FIG. 2 is an enlarged view of part A of FIG. 1.

FIG. 3 is a partially enlarged plane view of the slat according to the first embodiment of the present invention.

FIG. 4 is similar to FIG. 2, showing the lifting cord is pulled out.

FIG. 5 is a partially enlarged plane view of the slat according to the second embodiment of the present invention.

### DETAILED DESCRIPTION OF THE INVENTION

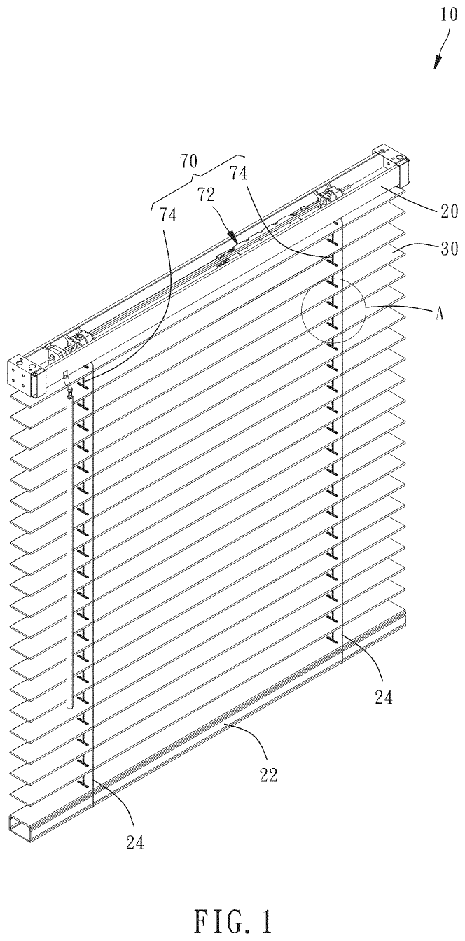

Referring to FIG. 1, a venetian blind 10 shown in FIG. 1 comprises a headrail 20, a bottom rail 22, a plurality of slats 30, and a transmission unit 70.

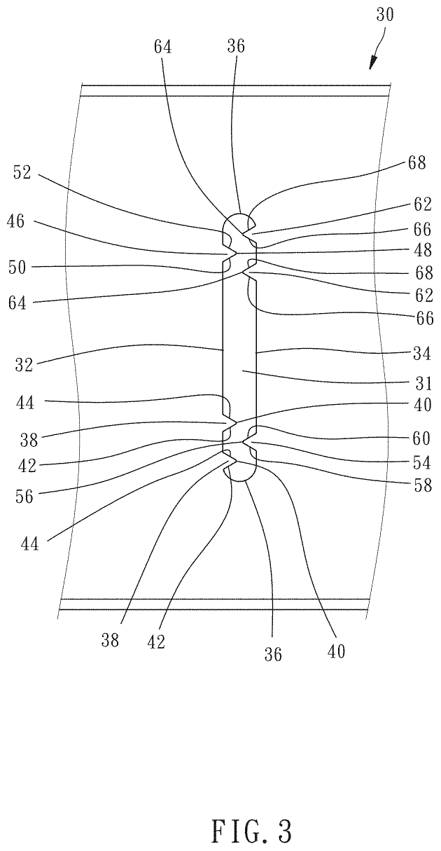

The slats 30 are arranged between the headrail 20 and the bottom rail 22 in a parallel manner by the connection of two ladder tapes 24. The slat 30 has an elongated through hole 31 at each of the left and right ends thereof. As shown in FIG. 3, the extending direction of the through hole 31 is perpendicular to the longitude direction of the slat 30. The periphery wall of the through hole 31 has a first wall surface 32, a second wall surface 34, and two curved end surfaces 36. The first wall surface 32 and the second wall surface 34 are opposite to each other. The end surfaces 36 are opposite to each other and connected with the front and rear ends of the first wall surface 32 and the front and rear ends of the second wall surface 34, such that the through hole 31 forms a closed loop.

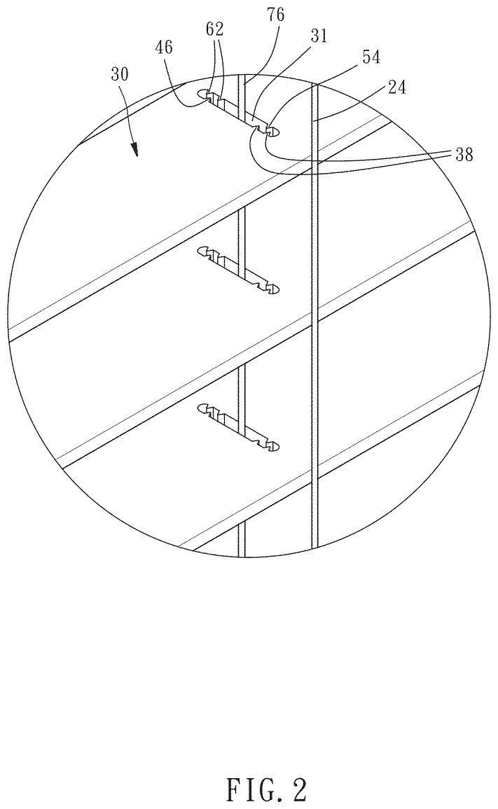

The transmission unit 70 includes a cord winder 72 and two lifting cords 74. As shown in FIGS. 1 and 2, the cord winder 72 is disposed in the headrail 20. The top ends of the lifting cords 74 are penetrated into the headrail 20 and connected with the cord winder 72, and the bottom ends of the lifting cords 74 pass through the through holes 31 of the slats 30 one by one and are connected with the bottom rail 22. By this way, the lifting cords 74 can be driven by the cord winder 72 to raise the bottom rail 22 for completing the folding of the slats 30, and the lifting cords 74 can be pulled by the bottom rail 22 to unfold the slats 30. Because the venetian blind 10 is not the key point of the invention, the detailed configuration will not be repeatedly mentioned hereunder.

As shown in FIG. 3, two first teeth 38 and a second tooth 46 protrude from the front and rear ends of the first wall surface 32 towards the second wall surface 34, respectively. The first teeth 38 each have a first tooth peak 40 defining a distance with the second wall surface 34 smaller than the lifting cord 74. The second tooth 46 has a second tooth peak 48 defining a distance with the second wall surface 34 smaller than the lifting cord 74. In addition, a third tooth 54 and two fourth teeth 62 protrude from the front and rear ends of the second wall surface 34 towards the first wall surface 32, respectively. The third tooth 54 is located between the first teeth 38 and staggered with respect to the first teeth 38. The second tooth 46 is located between the fourth teeth 62 and staggered with respect to the fourth teeth 62. The third tooth 54 has a third peak 56 defining a distance with the first wall surface 32 smaller than the lifting cord 74. The fourth teeth 62 each have a fourth tooth peak 64 defining a distance with the first wall surface 32 smaller than the lifting cord 74.

As shown in FIG. 3, the first teeth 38 each further have a first front tooth surface 42 and a first rear tooth surface 44. The third tooth 54 further has a third front tooth surface 58 and a third rear tooth surface 60. The first front tooth surface 42 of the first tooth 38 located behind the third tooth 54 and the third rear tooth surface 60 of the third tooth 54 are opposite and parallel to each other, and the distance between themselves is smaller than the diameter of the lifting cord 74. The first rear tooth surface 44 of the first tooth 38 located ahead of the third tooth 54 and the third front tooth surface 58 of the third tooth 54 are opposite and parallel to each other, and the distance between themselves is smaller than the diameter of the lifting cord 74. In addition, the second tooth 46 further has a second front tooth surface 50 and a second rear tooth surface 52. The fourth teeth 62 each further have a fourth front tooth surface 66 and a fourth rear tooth surface 68. The fourth rear tooth surface 68 of the fourth tooth 62 located ahead of the second tooth 46 and the second front tooth surface 50 of the second tooth 46 are opposite and parallel to each other, and the distance between themselves is smaller than the diameter of the lifting cord 74. The fourth front tooth surface 66 of the fourth tooth 62 located behind the second tooth 46 and the second rear tooth surface 52 of the second tooth 46 are opposite and parallel to each other, and the distance between themselves is smaller than the diameter of the lifting cord 74.

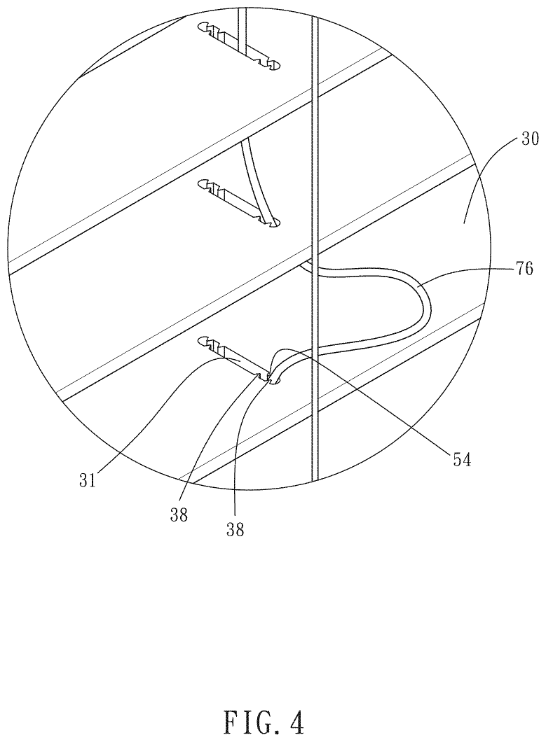

It can be seen from the above that when a lifting section 76 (i.e., the part located between the two adjacent slats 30) of the lifting cord 74 is pulled out by an external force, as shown in FIG. 4, the lifting section 76 is engaged between the first teeth 38 and the third tooth 54 along the extending direction of the through hole 31. Since the third front tooth surface 58 of the third tooth 54 and the third rear tooth surface 60 of the third tooth 54 are respectively corresponding and parallel to the first rear tooth surface 44 of one of the first teeth 38 and the first front tooth surface 42 of the other of the first teeth 38, and further, the distance between themselves is smaller than the diameter of the lifting cord 74, the lifting section 76 is easier to enter between the first teeth 38 and the third tooth 54 and then be confined, such that the lifting section 76 can't be pulled out continuously. This can prevent a rope loop formed by the lifting section 76 from being enlarged for enhancing the safety of use.

It needs to be added here that when the lifting section 76 of the lifting cord 74 is pulled out by an external force, the lifting section 76 may be engaged between the second tooth 46 and the fourth teeth 62 along another direction. Since the second front tooth surface 50 of the second tooth 46 and the second rear tooth surface 52 of the second tooth 46 are respectively corresponding and parallel to the fourth rear tooth surface 68 of one of the fourth teeth 62 and the fourth front tooth surface 66 of the other of the fourth teeth 62, and further, the distance between themselves is smaller than the diameter of the lifting cord 74, the lifting section 76 is also easier to enter between the second tooth 46 and the fourth teeth 62 and then be confined, such that the lifting section 76 can't be pulled out continuously. This can also prevent the rope loop formed by the lifting section 76 from being enlarged for enhancing the safety of use.

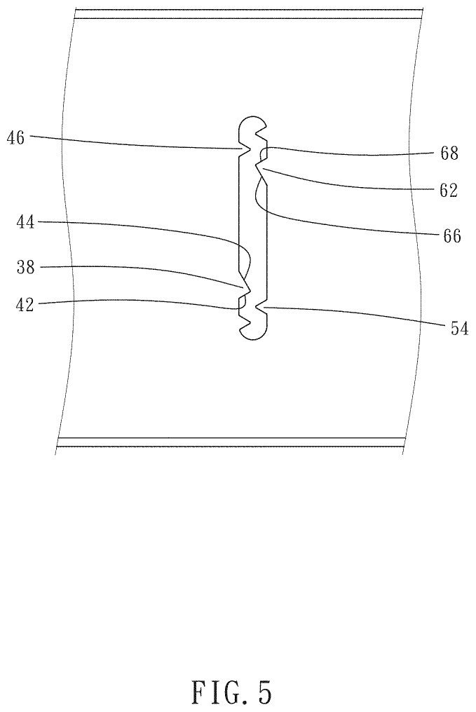

On the other hand, in aforesaid embodiment, the first front and rear tooth surfaces 42, 44 of the first tooth 38 have the same lengths. Actually, as shown in FIG. 5, in order to guide the lifting section 76 to enter between the first tooth 38 and the third teeth 54, the first tooth 38 located behind the third tooth 54 can be designed that the length of the first rear tooth surface 44 is greater than the length of the first front tooth surface 42. By this way, the lifted section 76 can smoothly enter between the first teeth 38 and the third tooth 54 along the first rear tooth surface 44; likewise, in aforesaid embodiment, the fourth front and rear tooth surfaces 66, 68 of the fourth tooth 62 have the same lengths. Actually, the fourth tooth 62 located ahead of the second tooth 46 can be also designed that the length of the fourth front tooth surface 66 is greater than the length of the fourth rear tooth surface 68. This can guide the lifted section 76 to smoothly enter between the second tooth 46 and the fourth teeth 62.

As indicated above, the slat 30 of the present invention uses multiple teeth arranged in a staggered manner at two ends of the through holes 31 to limit the continuous movement of the lifting section 76 when the lifting section 76 is pulled out for preventing the rope loop from being enlarged, thereby enhancing the safety of use. Further, the slat of the prevent invention is unnecessary to be machined a groove with a width smaller than the diameter of the through hole 31, and compared to the prior art, the slat 30 of the prevent invention is easier to be processed for lowering manufacturing cost. In addition, the first tooth 38 and the fourth tooth 62 are not limited to two in number.

The number of them can be reduced to one or increased to more than two according to actual needs. The second tooth 46 and the third tooth 54 are not limited to one in number. The number of them can be increased to more than two according to actual needs for achieving the effect of limiting the movement of the lift cord 74.

What is claimed is:

1. A slat for a venetian blind, comprising a through hole at each of left and right ends thereof for penetration of a lifting cord of the venetian blind, a periphery wall of each of the through holes includes a first wall surface, a second wall surface opposite to the first wall surface, and two opposite end surfaces connected with front and rear ends of the first wall surface and front and rear ends of the second wall surface, a first tooth and a second tooth protruding from the front and rear ends of the first wall surface towards the second wall surface, the first tooth having a first tooth peak defining a distance with the second wall surface smaller than a diameter of the lifting cord, the second tooth having a second tooth peak defining a distance with the second wall surface smaller than the diameter of the lifting cord, a third tooth and a fourth tooth protruding from the front and rear ends of the second wall surface towards the first wall surface, the third tooth and the first tooth being staggered with respect to each other, the fourth tooth and the second tooth being staggered with respect to each other, the third tooth having a third tooth peak defining a distance with the first wall surface smaller than the diameter of the lifting cord, the fourth tooth having a fourth tooth peak defining a distance with the first wall surface smaller than the diameter of the lifting cord.

2. The slat as claimed in claim 1, wherein the first tooth further has a first front tooth surface opposite and parallel to a third rear tooth surface of the third tooth, and a distance between the first front tooth surface of the first tooth and the third rear tooth surface of the third tooth is smaller than the diameter of the lifting cord, the second tooth further has a second front tooth surface opposite and parallel to a fourth rear tooth surface of the fourth tooth, and a distance between the second front tooth surface of the second tooth and the fourth rear tooth surface of the fourth tooth is smaller than the diameter of the lifting cord.

3. The slat as claimed in claim 2, wherein the first tooth further has a first rear tooth surface, and a length of the first rear tooth surface is greater than a length of the first front tooth surface.

4. The slat as claimed in claim 2, wherein the fourth tooth further has a fourth front tooth surface, and a length of the fourth front tooth surface is greater than a length of the fourth rear tooth surface.

5. The slat as claimed in claim 1, wherein two said first teeth protrude from the front end of the first wall surface towards the second wall surface; the third tooth is located between the two first teeth; two said fourth teeth protrude from the rear end of the second wall surface towards the first wall surface; the second tooth is located between the two fourth teeth.

6. The slat as claimed in claim 5, wherein the first teeth each have a first front tooth surface and a first rear tooth surface; the third tooth further has a third front tooth surface opposite and parallel to the first rear tooth surface of the first tooth located ahead of the third tooth, and a third rear tooth surface opposite and parallel to the first front tooth surface of the first tooth located behind the third tooth; a distance between the first front tooth surface of the first tooth located behind the third tooth and the third rear tooth surface of the third tooth is smaller than the diameter of the lifting cord, and a distance between the first rear tooth surface of the first tooth located ahead of the third tooth and the third front tooth surface of the third tooth is smaller than the diameter of the lifting cord; the fourth teeth each have a fourth front tooth surface and a fourth rear tooth surface; the second tooth further has a second front tooth surface opposite and parallel to the fourth rear tooth surface of the fourth tooth located ahead of the second tooth, and a second rear tooth surface opposite and parallel to the fourth front tooth surface of the fourth tooth located behind the second tooth; a distance between the fourth front tooth surface of the fourth tooth located behind the second tooth and the second rear tooth surface of the second tooth is smaller than the diameter of the lifting cord, and a distance between the fourth rear tooth surface of the fourth tooth located ahead of the second tooth and the second front tooth surface of the second tooth is smaller than the diameter of the lifting cord.

7. The slat as claimed in claim 6, wherein a length of the first rear tooth surface of the first tooth located behind the third tooth is greater than a length of the first front tooth surface of the first tooth located behind the third tooth.

8. The slat as claimed in claim 6, wherein a length of the fourth front tooth surface of the fourth tooth located ahead of the second tooth is greater than a length of the fourth rear tooth surface of the fourth tooth located ahead of the second tooth.

9. The slat as claimed in claim 1, wherein the through holes each have an elongated shape, and extending directions of the through holes are perpendicular to a longitude direction of the slat.
